(19) United States
(12) Patent Application Publication
(10) Pub. No.: US 2005/0236476 A1
(43) Pub. Date: Oct. 27, 2005

(54) Portable networked self-service terminals for product/service selection

(76) Inventors: Richard Harold Murray, Delta (CA); Phillips Ross Murray, Port Moody (CA)

Correspondence Address: Mr. Ross Murray, 2936 Spring Street, Port Moody, BC, V3H 4V8, CA

(21) Appl. No.: 10/831,579

(22) Filed: Apr. 26, 2004

(51) Int. Cl. G06K 15/00; G06F 17/60

(52) U.S. Cl. 235/383; 705/27

(57) ABSTRACT

This patent relates to a method and apparatus to provide portable networks of portable (moveable, e.g. table top or free-standing on wheels) self-service terminals designed to perform any or all of the following: product/service selection, payment acceptance, payment authorization or verification, communication via wire or wireless means for purposes including requesting product, service and/or payment authorization from local or remote network servers, to generate payment indicia in the form of tokens or tickets dispensed, such product/service selection/payment indicia to be human readable or optionally machine readable via bar code or other coding schemes, and optionally to include within a network, redemption terminals capable of reading the machine readable indicia, capturing and vaulting the tickets or tokens and generating confirmation of receipt of the payment indicia via visual or audible means to communicate to an attendant staff person. Self-serve product/service selection and payment is accomplished by user input data entry to a display screen with aligned buttons or “touch screen” capability.

### BACKGROUND OF THE INVENTION

1. Field of the Invention

The invention relates to portable networks of wireless self-service terminals for selecting and dispensing tickets for purchase of drinks and other commodities in a hospitality setting. Often described as “no host bars” at conventions and theatres, such environments also include confection stands at sport arenas but which can also apply to food or drink items in food courts or to rides in fairs. The invention also relates to a method for selecting and dispensing tickets using the self-service terminal.

2. Description of Prior Art

Self serve payment devices of several forms are well known in many industries. Similarly, card payment, particularly credit card payment at self-serve devices has been well known for many years. Indeed, one of the inventors in this instance published descriptions of self-serve credit card payment devices for the parking industry, and participated in manufacture and sale of such devices during the 1980's. Similarly, portable payment terminals, particularly handheld payment terminals featuring card payment options, have been used for years in several industries including food service.

The invention in this instance can be regarded as a marriage of the two concepts of self-service and portability in kiosk terminals and their supporting wireless networks. For some industries such as hotels, convention centres, performing arts venues, some food services and special event management the advantages of these self-serve devices have not been available because the venues require unique set-up configurations from one event to the next, and present a special problem requiring flexible connectivity combined with self-service and operator service. This requirement cannot be satisfied with fixed mount equipment or any existing equipment or patents.

The prior art solution to the problem of cash handling in respect of event item tickets is the use of specialized rolls of media stock sold by a cashier. Such stock and process can be difficult to control, and difficult to reconcile for financial purposes. Alternatives such as custom printed receipts from POS devices can be costly to configure for special events and even more difficult to reconcile. Payment handling at such events tends to slow down the customer service, or worse, force potential clients to seek automated cash machines in the vicinity.

### SUMMARY OF INVENTION

It is therefore an object of the invention to provide networks of self-service terminals that overcomes the disadvantages of the prior art.

It is also an object of the invention to provide networks of self-service terminals that are fully automatic in operation.

It is a further object of the invention to provide a simple and convenient method for configuring the networks and self-service terminals.

It is a further object of the invention to provide complete flexibility in deploying networks of self-service terminals to capitalize on user traffic flow to enable maximum product/service sales in a minimum of time.

It is a further object of the invention to minimize logistical obstacles such as access to power and communications for the networks.

It is a further object of the invention to provide a method for using the self-service terminals.

It is a still further object of the invention to provide such an improved self-service terminal that increases consumer participation and control in the selection and purchasing of product/service indicia.

It is a still further object of the invention to enable events to be configured with multiple self-service terminals to reduce queue times for purchase of said indicia.

In accordance with a feature of the invention, encrypted indicia are generated in order to prevent fraud.

It is a still further object of the invention to enable a consumer to purchase suitable indicia by easily proceeding through a series of menus on a display screen.

In accordance with a feature of the one such embodiment of the invention, the screen is a touch screen whereby the consumer can simply touch different areas of the screen to make appropriate selections.

In accordance with a feature of another such embodiment of the invention, the screen directs the user to make selections with adjacent buttons.

It is a still further object of the invention to provide a self-service terminal that permits a purchaser to pay for selections with multiple payment methods such as a credit/debit card and/or smart card.

In accordance with the invention networks of self-service terminals are provided for product/service selection and payment, each self-service terminal comprising an output display screen with optional “touch screen” capability to receive user input data entry or an output display with buttons, a printer and a means for communicating with remote databases.

In one such implementation, product selection is accomplished by the depression of separate buttons, paid with a credit or debit card, and proof of purchase is dispensed by roll-fed tickets or by printing a custom ticket. The ticket is marked in such a way as to prevent fraudulent use of ticket stock when dispensed. The printer is arranged to print product or service information onto a token, such as a unique machine-readable bar code, as well as an optional receipt for the total purchase transaction.

Said networks may contain one or multiple self-service terminals, communications means, multiple databases, and one or more payment methods, and each said self-service terminal comprising:
a terminal controller and an associated output display screen;
said terminal controller including memory means for storing data concerning said plurality of products/services;
said terminal controller being programmed to permit a user to select one or more products/services;
said self-service terminal further including:
means for receiving payment for said selected products/services through access to financial authorization databases;
   means for dispensing indicia for said selections such as tokens or bar-coded tickets; and
   means for effecting communication between said terminal controller and said means for authorizing the transaction;
      whereby, said means for dispensing said indicia are under the control of said terminal controller.

Each self-service terminal is powered by combinations of battery and/or high capacity condenser with power delivered to these storage devices by AC power and/or solar power.

In one implementation, the means of communicating among the terminals and the databases is wireless radio frequency with a concentrator enabling secure access to public data networks.

The remote databases contain financial authorization information regarding the purchase of each token, as well as product, supply, pricing and sales information.

The invention provides a method of selecting and dispensing indicia to a user, at any one of a plurality of self-service terminals, for a plurality of transactions on the basis of a plurality of products/services, each transaction having a plurality of elements, each self-service terminal having a terminal controller, each terminal controller including memory means for storing data concerning said plurality of transactions, each of said terminal controllers being in communication with a multiplicity of processors maintaining databases for financial authorization, product/service information, sales reporting, financial tracking and accounting;
said method comprising:
A) said user activating one of said self-service terminals, whereby said terminal provides data to said associated output display device so that said display screen presents an initial screen listing said products/services, whereby said user can select one of said products/services, or one category of said products/services, followed by multiple selections of said products/services;
B) repeating step A) until each element of each one of the plurality of products/services has been separately listed, and has been selected;
C) effecting a payment with said self-service terminal wherein said means for receiving payment comprises any one or combination of a credit and/or debit card reader and/or smart card reader;
D) receiving appropriate indicia reflecting selections made and payment approved by recognizing and validating the appropriate value provided by the user (such as a credit card charge);
E) presentation of said indicia for product/service fulfillment by a human operator directly or by means of a special terminal which will accept and read the indicia, present the product/service selections to the human operator for fulfillment and account for the sale for reporting and financial reconciliation.

### BRIEF DESCRIPTION OF DRAWINGS

In FIG. 1, we portray a typical example of the network topology for the invention.

In FIG. 2, we diagram an alternative network setup, one of many choices, this one uses a TCP/IP network for communications between locations.

FIG. 3 shows an example of the self-service terminal that dispenses roll-fed tickets from a one four different ticket types.

FIG. 4 shows a version of the self-service terminal that prints indicia as tokens such as bar codes for the purchase, as well as production of financial receipts, in this instance offering eight choices at each level of the display menu options presented.

FIG. 5 shows a version of the self-service terminal that utilizes a touch screen for user inputs.

FIG. 6 shows examples of touch screens employed in the embodiments depicted in FIG. 5 showing different deployments in food service as well as a theatre venue.

FIG. 7 shows the software displays that control the operation of the network.

FIG. 8 shows the event setup process that the customer uses to deploy the terminal to a specific event type.

FIG. 9 show the same event setup process for the eight-button version of the terminal.

FIG. 10 is the process for configuring the content of the receipt printed by the terminal.

FIG. 11 is an example of one of the many reports that the system generates.

### DESCRIPTION OF PREFERRED EMBODIMENTS

In accordance with the current invention, the preferred embodiment is a network of portable terminals or kiosks for the purposes of transaction processing and/or information access, provided to meet the requirements of various venues in the hospitality, convention and entertainment industries. The terminals so provided are typically configured to operate from battery power and to communicate via hybrid networks combining wired elements with short-range data radios. The self-service terminals thus provided are portable and easily configurable as a network with real-time data communications to allow live transaction authorization and processing and to allow real-time local access to data retrieved from remote sources.

A typical network configuration for the preferred embodiment, as shown in FIG. 1, incorporates a local network server (101) acting as a gateway for remote transaction authorization via a bank server or other service provider (102). Communication between the local network server (101) and the bank server or other service provider can be by telco (“Telecommunications Service Provider”) dialup, dedicated telco line, or TCP/IP connection. The local network server (101) also acts to provide operational information such as event configuration data to the transaction terminals (103). In the network as depicted in FIG. 1, communication from the local server to the transaction terminals is via a hybrid network to accommodate the variable demands of different hospitality venues. In this embodiment local installed telephone lines are used to connect one or more RF (“Radio Frequency”) network hubs (105) to the network server (101). This permits the management of one and/or several networks from a single server. These networks can be located at one and/or more locations and can be parts of one and/or several different events.

Use of existing telephone lines allows network installation at minimal cost. To meet the requirements of machine portability and ease of configuration, data radio communication is used for the final link to the transaction terminals (103). In the depicted configuration the local server (101) also serves as master for the local network(s) and administers the network-polling regimen. In this configuration the network hubs (105) consist essentially of a telco modem and a data radio configured back to back for the purpose of mastering the local subnet. The network hubs (105) can communicate to the transaction terminals (103) on a point-to-point or point-to-multipoint basis.

The equipment embodied in this description can also be configured in simpler network topologies. For example the local telco links can be deleted and the network hubs (105) can be replaced with RF data radios similar to those in the transaction terminals and connected directly to the local facility server (101) via serial data cable. In these configurations the range limit between the local facility server (101) and the RF hubs (105) is more restricted, e.g. 100 feet for RS232 or 4000 feet for RS485.

The network topology of FIG. 1 shows a typical implementation of the invention for autonomous operation of a local facility. In a second configuration employing Internet communications and real-time remote service bureau functionality this invention is deployed without the requirement for a real-time accessible local facility server. FIG. 2 depicts a configuration in which the facility server function can be remote and no local computer need be dedicated on a real time basis. In this configuration the server is remote (111) from the local venue and is typically a service provided at a remote facility operated by a third party such as Burrard Technologies.

In this configuration each transaction terminal shall have a unique TCP/IP address and the wireless component of the network shall conform to one of the 802.11 standards. In this case the RF network hub (125) is a commercial product such as a wireless router supporting 802.11g. In this topology, each ticketing terminal (103) can be directly addressed from multiple external devices for purposes of configuration, remote support and maintenance. The topology allows for all real time communications needs of each transaction terminal to be provided from a remote server (111) where guaranteed 24 hour availability can be provided without reference to local staffing or equipment resources.

FIGS. 1 and 2 represent only two of several possible network topologies conforming to the invention. For example, in FIG. 2, the local facility client (104) could also act as the server, eliminating the remote server (111) and transmitting directly over the web to the bank server (102). In any of the potential network topologies the primary objective of the invention is to provide portable networks of self serve terminals for the purposes of real time transaction processing or information access.

One configuration of self-serve terminal incorporated in the preferred embodiment of the invention is a portable ticket sales machine for the hospitality industry configured to sell preprinted Skee-Ball type tickets and designed to accept card payment. In the preferred configuration credit cards from the major card associations are accepted. Other forms of cards, including but not limited to debit cards, credit cards from minor issuers and smart cards with stored value capability could also be accepted.

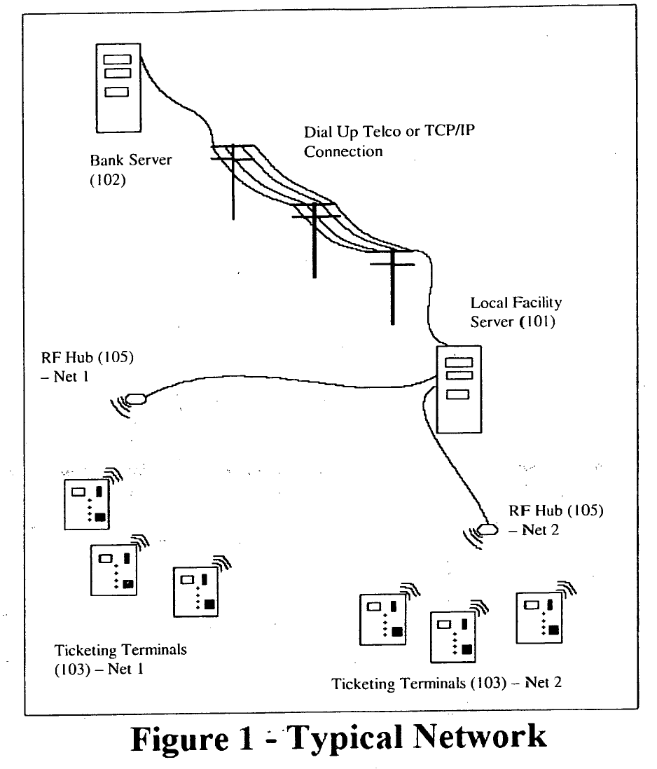

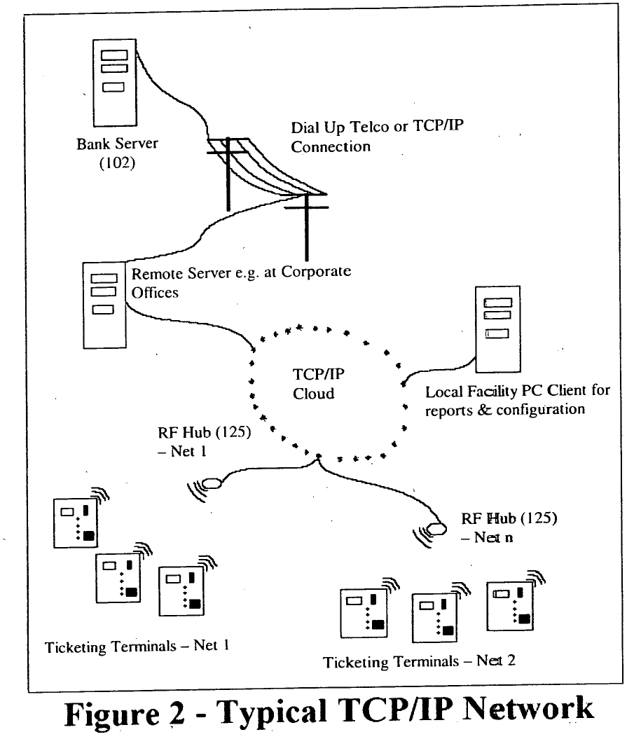

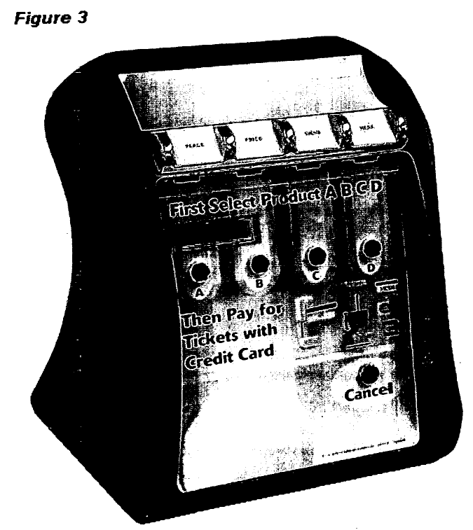

FIG. 3 is a photograph of a ticketing (103) machine operating as described immediately above and configured as a client on a network as depicted in FIG. 1. The ticketing machine is configured to quickly change setup parameters to meet the needs of each event in which it is deployed. To achieve this objective the setup parameters for each event are predefined and stored in the server (101) for download. When the ticketing machine is deployed to a new event it can query the server for a list of available event definitions and allow the setup staff to select and download the setup files for the event.

The machine as shown in FIG. 3 dispenses pre-printed tickets through four ticket delivery mechanisms. The machine as depicted is therefore limited to four ticket types. This embodiment can be enabled to deliver more than four ticket types by addition of more ticket delivery mechanisms and more selection buttons. In this machine the tickets are physically embossed at time of delivery to make it evident that the tickets were sold through the system of self serve terminals. The machine as shown is battery powered and communicates via a network as depicted in FIG. 1. The machine can therefore be located and can operate anywhere within range of the RF Hub (105). The machines incorporate battery management circuitry and will automatically recharge the batteries and then maintain the batteries at optimum charge while connected to their power supply modules when not in service. The machines are capable of operating normally while the batteries are being charged. They are also capable of continuous service with the power supply modules connected. The machines are housed in secure cabinets constructed of glass reinforced plastic and steel elements. The machines are serviced via a door in the rear panel. The door is fitted with a key operated cam lock for security of the machine and the ticket stock stored within it.

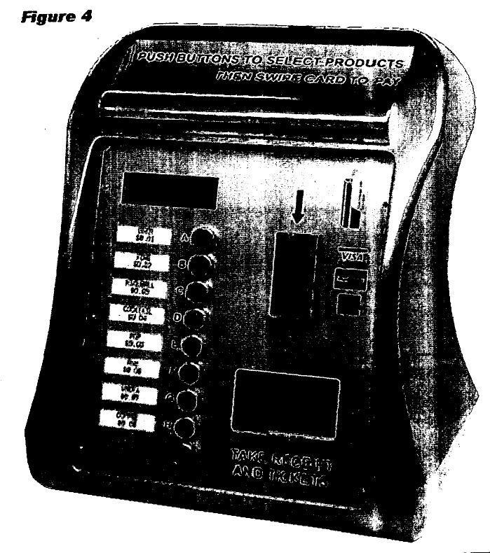

FIG. 4 is a photograph of a ticketing (103) machine configured again as a portable terminal on the hybrid network as depicted in FIG. 1. This version of the machine is fitted with a thermal printer for dynamic generation of the tickets and customer receipt. It does not include dispensers for preprinted tickets as described in the earlier machine.

This embodiment of the machine allows eight ticket types, and this number can be increased by incorporation of additional ticket selection buttons. The ticket content is completely flexible and both text and images may be selected or modified by the user. This can identify the product sold, company information, or cross-merchandising opportunities. Thus the number of different ticket types available is unlimited, with the maximum number being used for any given event deployment being limited to the number of ticket selection buttons provided. Tickets are also serialized so that individual tickets can be cross-referenced to transactions.

The user can also change the receipt content. They can select many different features such as the company logo, name, address, telephone numbers, email address or URL. Tax names and rates can be added, as can tax registration numbers if so desired. Cross-merchandising messages are also an option in this embodiment.

Reporting and other management features available from the ticketing machine are accessed through a menu displayed on the character display. To access the menu, the operator uses a specially encoded magnetic stripe card called an Operator Card. Swiping the Operator Card in the card reader puts the unit into management mode and gives access to the ticketing machine menu. The Operator Card is stored inside the locked cabinet door, thus providing authorized personnel with secure access to management functions.

The machine in FIG. 3 displays reports to the character display. Reports can be generated easily at any time. Operators can access progress reports during an event or end-of-night reports after the event has closed. The use of a printer in the machine in FIG. 4 enhances reporting. Sales reports can be printed quickly and efficiently. In addition to the progress and end-of-night reports available on the character display, the unit depicted in FIG. 4 can create and print reports from the server and those reports can include data from one or several machines. The embodiment shown in FIG. 4 uses a 4-line by 20-character LCD for user messaging. This machine also operates from battery power and again incorporates internal battery management circuitry.

Another embodiment of the system can employ a remote printer and/or monitor as a node on the network so that, for example, a customer can receive her tickets and receipt simultaneously with the printing and/or display of a duplicate order to the server. In this application the server can then call the client to pick up their order by using matching indicia printed on the receipt/tickets and the server order.

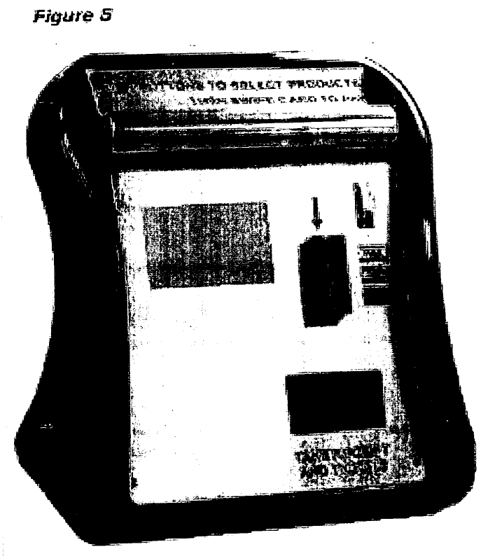

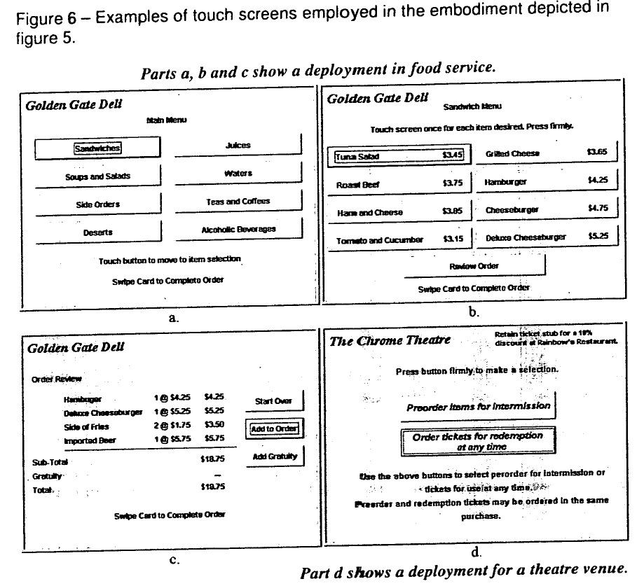

In other embodiments the user interface employs a touch screen for both user messaging and user input (FIG. 5). Using a nested menu structure these embodiments allow essentially unlimited ranges of selections (FIG. 6 a, b, and c). These embodiments can operate from battery power, incorporate internal battery management circuitry, and are capable of continuous service with power modules connected to external power. These embodiments again are portable and easily configurable as networks with real-time data communications to allow live self-serve transaction authorization and processing. They also allow real-time local access to data retrieved from remote sources for configuration and reporting purposes. These embodiments also incorporate all of the ticket and receipting features described above for the embodiment depicted in FIG. 4.

Another important feature of the invention is that the machines can be set to sell tickets for redemption and/or to pre-order commodities for use later in the event. For example, in a concert venue it may be desirable to pre-order food and/or beverages for the intermission (FIG. 6 d). It may also be desirable to identify a pick-up location for the order. For example a client in an upper balcony will not want to return to the main lobby. For this instance the machine can be configured to let the client select the pick-up location from a preset list of alternatives. For presale of commodities the machine can be configured to issue uniquely numbered chits for redemption at intermission. The operator can then call an order list from any machine on the network. The operator can call orders from an individual machine and/or a group of machines, up to and including the entire network. The order list will give the operator the requested list of orders, where each is to be left for pickup, and issue matching uniquely numbered chits so that the guests can retrieve their orders by simply matching the numbers on their individual chits to those on the chits left with the orders. The machine can also be configured to provide these features in addition to selling redeemable tickets, such that a client may purchase a commodity for consumption prior to the start of the show and pre-order intermission commodities in the same transaction.

Portable machines will sometimes be located where network communication might be interrupted. To enhance machine portability and user convenience, the system incorporates an optional mode of operation known as simulated live authorization (“SLA mode”) in case of interrupted communications. With SLA mode enabled the devices will process transactions and give the impression of having authorized the transactions in advance while in fact storing the transaction data for later processing. In this way, the event operators can elect to set the machines in a mode where they will continue operation without any visual cue to the user when communication is interrupted. The devices will automatically seek to re-establish network communication and, on re-establishment of data communications, the devices will upload transaction data in background to the host computer for immediate processing, thus restoring the network to full real-time communication functionality. Should the automatic functionality fail to re-establish network communications, the devices will continue to operate in this mode and store transactions for subsequent upload and authorization.

In one embodiment of the invention the system shall include an automated ticket recognition and redemption machine. This device shall recognize machine readable indicia generated in bar code on the tickets from the thermal printer or similarly preprinted bar codes on preprinted tickets and shall record and vault each ticket as presented. The machine-readable indicia could uniquely identify each transaction and item purchased but will typically identify only the product type to be exchanged for the ticket presented.

One of the challenges in the hospitality and entertainment industries is to quickly count and reconcile all receipts at the end of an event. For many events the time available for settlement is very limited and consequently financial controls are compromised. Reconciliation, for many venues, must be performed separately for each bar or product delivery location. It is an object of the invention, with the redemption machine, to automate the ticket counting process to thereby allow rapid settlement of each delivery location and to bring the resulting information into the network for automated, consolidated reporting of event receipts.

To be effective this reconciliation must be able also to accept tickets issued at cashier operated ticket sales stations. For preprinted tickets, this requirement can be met by issuing tickets with machine-readable indicia pre-encoded. For systems with dynamic ticket printing at the ticketing terminals the above requirement shall be met by cashier operated ticket sales machines with ticket printing capability similar to the ticketing terminals.

The invention is fundamentally one or more portable networks of devices allowing for rapid deployment and configuration of the portable machines. As depicted in FIG. 1 and FIG. 2 the network server(s) can be local to the event or remote from the event site or sites. In either case, the networks incorporate a feature to allow the operating parameters for the portable terminals to be configured on computer(s) external to the portables and to be loaded to the portables via the network prior to each event. This feature is a fundamental element allowing for the portables to be quickly configured to meet the needs of each event. The portable machines, acting as network clients, are able to establish communications with the network, address the network server(s) and retrieve the event configuration files as necessary.

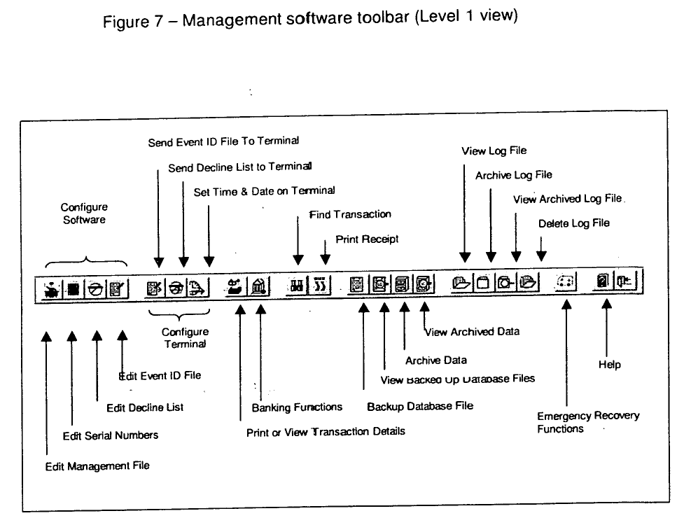

In the preferred embodiment a Pentium class Windows PC is used as a configuration and reporting node on the network. Typically, per FIG. 1, the same machine also performs as the network transaction server. A graphical user interface is provided for network administration and reporting. A screenshot of the main toolbar for the standard interface is shown in FIG. 7. The toolbar provides a quick, easy way to launch all the windows used to configure and manage the portable ticketing stations. The network administration software provides stratified access depending upon the privileges assigned to each user. FIG. 7 represents the highest administrative level, Level 1.

System management software provides the tools for the administrator to define the event setup parameters for the portable machines and to store the setup files for subsequent retrieval by the portable machines. This procedure allows the portables to be quickly reconfigured for each event as required.

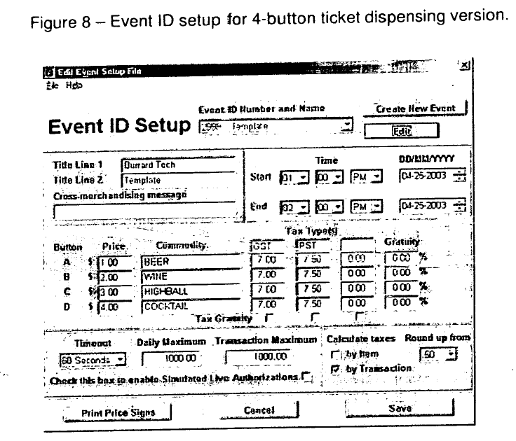

FIG. 8 shows the event setup window used to configure event information for a system of four-selection ticket dispensing machines as shown in FIG. 3. The Event Setup window provides control of the following parameters for configuration of the portable machines:
Create Event ID's.
Messages for the LCD display
Prices for individual buttons.
Commodity names for buttons.
Start and end times and dates for Event ID's.
Taxes applicable to product prices for each commodity.
Application of gratuities to selling prices
Application of taxes to gratuities
Daily maximum for individual credit cards.
Ticketing terminal timeout settings.
Tax calculation rules
Rounding rules

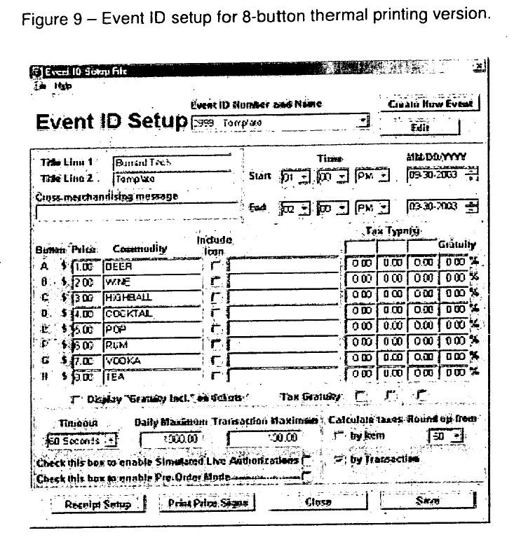

FIG. 9 shows the event setup window used to configure event information for a system of eight-selection ticket printing machines as shown in FIG. 4. The Event Setup window provides control of all the above configuration parameters and also allows control of text and icons to be printed on each of the ticket types.

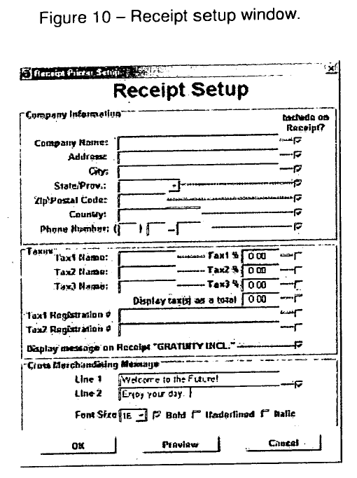

The ticket printing machines also generate printed receipts with each transaction and the receipts are also configured from within the system management software (FIG. 10). Similar user-friendly setup windows are provided for this and many other features of the host software package.

The network also provides several reporting options for management use. As with the setup options the reporting features are configured and accessed with user-friendly GUI menu pages on the host PC. Reports can be directed to the computer console or to printing resources. The system provides two basic logical structures of reports. First are the event-based sales and activity reports. Event based reporting features include the following:
Sales Mix Report
Sales by Machine
Detailed Transaction Report

The second reporting structure is financial reporting based on transaction processing into the banking system. Detailed and summary reports are available as follows:
Banking Detail Report
Batch Report

The above noted event reporting capability is a key feature of the network as described herein. The system supports dynamic configuration and deployment of the portable devices to different events as needed. This creates a significant potential for transactions and revenues to be attributed to the wrong events as machines are moved to meet demand. Client billings in many hospitality settings, for example, are influenced or driven by bar sales at the events. It is therefore critical that event reporting accurately distinguish where sales occur. To resolve this issue the ticketing terminal system embeds the event ID in each transaction record so the reporting system can accurately select all appropriate records when generating event reports. Event reports are easily created and they automatically summarize all relevant data to allow convenient and accurate reporting of event sales.

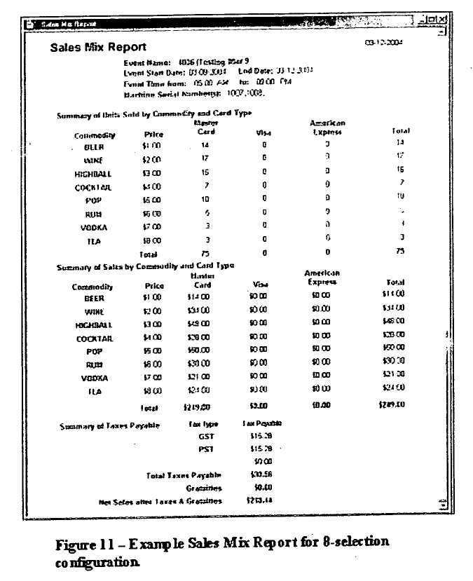

A sample sales mix report is shown as FIG. 11 for reference.

In all embodiments presented herein, the onboard computer that operates the portable device is equipped with an error sensing system. In the event of an error in the device, the device will notify the server of the error. The host software is configurable to provide a service call-out to a designated service provider. Such notification can be by pager, email, text message, text-to-voice message or other methods. A typical example would be a “paper out on unit XXXX” message delivered to an on-site attendant who could then proceed to the device and replenish it's paper supply, thereby minimizing out-of-service time.

1. A method for selecting and purchasing products/services at one or more portable networks of portable self-service terminals, the self-service terminal having a display screen, input via buttons or touch screen, a card reader, an output device for producing indicia of selection, purchase and authorization such as a printer, a communications device and a terminal controller, the steps comprising:
displays of product or service offerings on the display screen to guide user selection and displays of special notices to accomplish a specific purpose with the potential purchasers such as awareness of special promotions,
product/service selection through interactions with the terminal by depressing appropriate buttons under directions on the screen or by direct pressing of a touch screen,
inserting a financial card into the card reader to provide data about a user; communicating with a remote database to transmit user and transaction data to a remote database and to receive information such as transaction authorizations, security data and general information as requested by the users from the remote database;
production of indicia on an output device such as printer, the terminal controller also optionally generating machine readable indicia such as a unique bar code based upon the security information and selection made;
presentation of the output indicia at one or multiple locations for fulfillment of some or all of the product/services authorized.
Communication is provided to several distinct databases such as: financial authorization, product/service information, sales reporting, financial tracking and accounting. The communications paths to each of said databases may be the same or different means in any specific network.
Throughout the specification the term indicia is intended to mean any ticket, voucher, slip, receipt or mechanism which is intended to be redeemed for products/services, by the purchaser thereof.

2. Networks as defined in claim 1 wherein said means for communications is a wireless connection to an onsite concentrator.

3. Networks as defined in claim 1 wherein said means for communications is a wired connection to the infrastructure of the venue

4. Networks as defined in claim 1 wherein said means for communications is via a public data network.

5. A self-service terminal as defined in claim 1 wherein said means for display is a liquid crystal display, a light-emitting diode display, a cathode ray tube, a TFT display or a plasma display (the “output display”).

6. A self-service terminal as defined in claim 1 wherein said means for display is touch sensitive enabling user data input.

7. A self-service terminal as defined in claim 1 wherein said means for display directs user input via buttons adjacent to the display.

8. A self-service terminal as defined in claim 1 wherein said means for user data input is a keyboard or keypad.

9. A self-service terminal as defined in claim 1 wherein said means for receiving payment comprises any combination of a credit and/or debit card reader and/or smart card reader.

10. A self-service terminal as defined in claim 1 wherein said means for dispensing indicia comprises ticket printer means under the control of said terminal controller.

11. A self-service terminal as defined in claim 10 wherein said means for dispensing indicia comprises machine-readable barcodes.

12. A self-service terminal as defined in claim 10 wherein said means for dispensing indicia comprises human readable notations on the printed ticket.

13. A self-service terminal as defined in claim 1 wherein said means for dispensing indicia comprises roll-fed pre-printed ticket stock.

14. A self-service terminal as defined in claim 13 wherein said means for creating indicia upon authorized payment includes perforating the roll-fed pre-printed tickets when dispensed.

15. A self-service terminal as defined in claim 1 wherein said means for dispensing indicia comprises machine-readable media such as smart cards or magnetic strip stock.

16. Networks as defined in claim 1 wherein the remote terminal could optionally be set to perform normally in the event of failure of data communications and produce said indicia while storing the transaction data for subsequent authorization by the card-issuing institution.

17. Networks as defined in claim 16 wherein the remote terminal will be set to automatically seek re-establishment of data communications in the event of failure of data communications and will return to normal live authorization procedures when data communications are re-established.

18. Networks as defined in claim 17 wherein the remote terminal will, upon re-establishment of data communications, transmit any stored transaction data to the host computer for immediate background processing and authorization by the card-issuing institution such that all databases and reports will be brought to current as quickly as possible after the resumption of data communications and without interfering with ongoing performance of the remote terminals.

19. Networks as defined in claim 18 wherein the remote terminal will perform the functions described in claim 18 while giving the appearance of proceeding through the steps of live authorization such that the operator's risk of credit card fraud resulting from the failure in data communications is minimized.

20. A self-service terminal as defined in claim 1 wherein said means for power is delivered from power storage devices such as batteries or capacitors and supply of power to, and recharging of, said devices is achieved by using AC power and/or solar panels.

21. A personal computer software suite is provided which enables the seller of the product/service to: configure the set of terminals and networks, set product/service descriptions and prices, and report sales by terminal, by product/service and in total.

22. A personal computer software suite as defined in claim 21 wherein an “Event Setup” window can be accessed giving the operator the ability to configure Event ID, event start and end times and dates, messages for the display screen, prices for individual buttons, commodity names and/or icons for individual buttons, taxes applicable to product prices for individual commodities, application of gratuities to selling prices whether fixed by the operator or set by the customer at time of purchase, application of taxes to gratuities, daily maximum for individual credit/debit/stored value cards, remote terminal time-out setting, tax calculation rules and rounding rules.

23. A personal computer software suite as defined in claim 21 wherein a “Receipt Setup” window can be accessed giving the operator the ability to configure receipt features including corporate information, graphic elements, applicable tax and gratuity information, and cross-merchandising messages.

24. A personal computer software suite as defined in claim 21 wherein a “View Reports” window can be accessed to easily and quickly access reports including sales mix reports, sales reports by remote terminal, detailed transaction reports and banking reports.

25. The method in claim 1 can also include a redemption terminal which can automate the exchange of indicia for product/service as defined in claim 1 by reading the machine readable indicia to confirm payment and by displaying to the person fulfilling the purchase the types and amounts to be provided and then recording the product/service sales for accounting reconciliation. These terminals can also communicate on the networks described in prior claims to facilitate enhanced control and reporting features network to communicate regarding authorizations and sales made on the self-service terminals as defined in claim 1.

26. A method of selecting and dispensing indicia to a user, at any one of a plurality of self-service terminals, for a plurality of transactions on the basis of a plurality of products/services, each transaction having a plurality of elements, each self-service terminal having a terminal controller, each terminal controller including memory means for storing data concerning said plurality of transactions, each of said terminal controllers being in communication with a multiplicity of processors maintaining databases described in claim 1;
said method comprising:
A) said user activating one of said self-service terminals, whereby said terminal provides data to said associated video display device so that said display screen presents an initial screen listing said products/services, whereby said user can select one of said products/services, or one category of said products/services, followed by multiple selections of said products/services;
B) repeating step A) until each element of each one of the plurality of products/services has been separately listed, and has been selected;
C) effecting a payment with said self-service terminal as defined in claim 9;
D) receiving appropriate indicia reflecting selections made and payment approved as described in claims 10 through 15;
E) presentation of said indicia for product/service fulfillment by a human operator directly or by means of the terminal described in claim 25.

27. Networks as defined in claims 1, and 10 through 13 wherein a duplicate copy of the indicia can be printed such that service personnel can prepare the customer order and then deliver the customer order by placing the completed order for pickup by the customer at a specified location complete with duplicate indicia to identify the order to the customer.
